(19) United States
(12) Patent Application Publication
(10) Pub. No.: US 2022/0185336 A1
(43) Pub. Date: Jun. 16, 2022

(54) VEHICLE

(71) Applicants: HYUNDAI MOTOR COMPANY, Seoul (KR); KIA CORPORATION, Seoul (KR); HYUNDAI AUTOEVER CORP., Seoul (KR)

(72) Inventors: Kyung Jun Kim, Seoul (KR); Seung Hwan Shin, Seoul (KR); Bong-Ju Kim, Yongin-si (KR)

(73) Assignees: HYUNDAI MOTOR COMPANY, Seoul (KR); KIA CORPORATION, Seoul (KR); HYUNDAI AUTOEVER CORP., Seoul (KR)

(21) Appl. No.: 17/526,684

(22) Filed: Nov. 15, 2021

(30) Foreign Application Priority Data
Dec. 10, 2020 (KR) 10-2020-0172546

(51) Int. Cl. B60W 60/00; B60W 50/08; B60W 50/14; B60W 40/02; B60W 10/26; G01C 21/34; G01C 21/36; B60L 58/13

(52) U.S. Cl. CPC B60W 60/0053; B60W 60/0023; B60W 50/082; B60W 50/14; B60W 40/02; B60W 10/26; B60W 2510/244; G01C 21/3492; G01C 21/3679; G01C 21/3697; B60L 58/13; B60W 2050/146; G01C 21/3469

(57) ABSTRACT

Disclosed is a vehicle performing autonomous driving. The vehicle includes: a display, a driver to drive the vehicle, an inputter configured to receive destination information related to a destination of the vehicle, a power supply including a battery for supplying electric power to the vehicle, a first sensor module to detect a capacity of the battery, and a controller to determine an expected driving route of the vehicle based on the destination information. The controller calculates an expected power consumption of the vehicle based on the expected driving route, and changes an autonomous driving state of the vehicle in the expected driving route based on the expected power consumption and the detected capacity of the battery.

### CROSS-REFERENCE TO RELATED APPLICATION(S)

This application claims priority to and the benefit of Korean Patent Application No. 10-2020-0172546, filed on Dec. 10, 2020, the entire contents of which are incorporated herein by reference.

### FIELD

The present disclosure relates to a technology related to an autonomous vehicle that efficiently manages electric power.

### BACKGROUND

The statements in this section merely provide background information related to the present disclosure and may not constitute prior art.

Autonomous driving technologies for vehicle are designed to automatically drive a vehicle by identifying road conditions without a driver controlling a brake, a steering wheel, or an accelerator pedal, and the like.

An autonomous driving technology is a key technology for realizing smart cars. As for autonomous vehicles, the autonomous driving technology includes a highway driving assistance (HDA) system that automatically maintains a distance between vehicles, a blind spot detection (BSD) system that detects nearby vehicles in a backward direction and sounds an alarm, an autonomous emergency braking (AEB) system that operates a brake device when a vehicle in front is not recognized, a lane departure warning system (LDWS), a lane keeping assist system (LKAS) that compensates for lane departure without a turn signal, an advanced smart cruise control (ASCC) technology that maintains a preset speed while maintaining a distance between vehicles, a traffic jam assist system (TJA), a parking collision-avoidance assist (PCA), and a remote smart parking assist system, and the like.

On the other hand, a conventional autonomous driving performing the above-described operations consumes a large amount of power to operate the hardware included in the vehicle.

### SUMMARY

The present disclosure provides a vehicle capable of providing optimized autonomous driving by distributing appropriate power based on a battery voltage and road information.

Additional aspects of the disclosure are set forth below in part in the description, should be obvious from the description, or may be learned by practice of the disclosure.

In accordance with an aspect of the present disclosure, a vehicle performing autonomous driving includes a display, a driver configured to drive the vehicle, an inputter configured to receive destination information related to a destination of the vehicle, a power supply including a battery for supplying electric power to the vehicle, a first sensor module configured to detect a capacity of the battery, and a controller configured to determine an expected driving route of the vehicle based on the destination information, calculate an expected power consumption of the vehicle based on the expected driving route, and change an autonomous driving state of the vehicle in the expected driving route based on the expected power consumption and the detected capacity of the battery.

The controller may be configured to control the vehicle to reach the destination by performing autonomous driving optimized for the expected driving route when the capacity of the battery exceeds the expected power consumption.

The vehicle may further include a communicator configured to receive road information, wherein the controller may be configured to receive the road information in response to a driving area where the vehicle is expected to travel while driving along the expected driving route, and calculate the expected power consumption based on the road information of the driving area.

The road information may include an amount of traffic, a driving difficulty, and types of roads in the driving area.

The controller may be configured to output a message guiding a switching from autonomous driving to manual driving on the display in at least a part of the driving area based on the power consumption,

The controller may be configured to change a level of autonomous driving of the vehicle in at least part of the expected driving route based on the power consumption of the vehicle and the capacity of the battery.

The vehicle may further include a second sensor module including: a radar, and a light detection and ranging sensor (lidar), wherein the controller is configured to change the autonomous driving state of the vehicle by controlling power supplied to the second sensor module based on the power consumption of the vehicle and the capacity of the battery.

The controller may be configured to output a message guiding the vehicle to pass through a charging station on the display when the expected power consumption exceeds the capacity of the battery.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a view showing a control block diagram according to an embodiment;

FIG. 2 is a view showing an operation of outputting a message guiding manual driving in autonomous driving according to an embodiment;

FIG. 3 is a view showing an operation of changing an autonomous driving state according to an embodiment;

FIG. 4 is a view showing an operation in which a user sets a destination and a vehicle determines an amount of power consumption corresponding to the destination, according to an embodiment;

FIG. 5 is a view showing an operation of controlling power according to an amount of traffic on a driving route according to an embodiment;

FIG. 6 is a view showing an operation of managing power when driving on a road having a low driving difficulty according to an embodiment;

FIG. 7 is a view showing an operation of guiding a charging station according to an embodiment; and

FIG. 8 is a flowchart according to an embodiment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Reference is now made in detail to the embodiments of the present disclosure, examples of which are illustrated in the accompanying drawings, wherein like reference numerals refer to like elements throughout. The present disclosure does not describe all elements of the disclosed embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the present disclosure, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements disclosed in the present disclosure, and are not intended to preclude the possibility that one or more other elements may exist or may be added.

Throughout the present disclosure, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, embodiments of the present disclosure are described in detail with reference to the accompanying drawings.

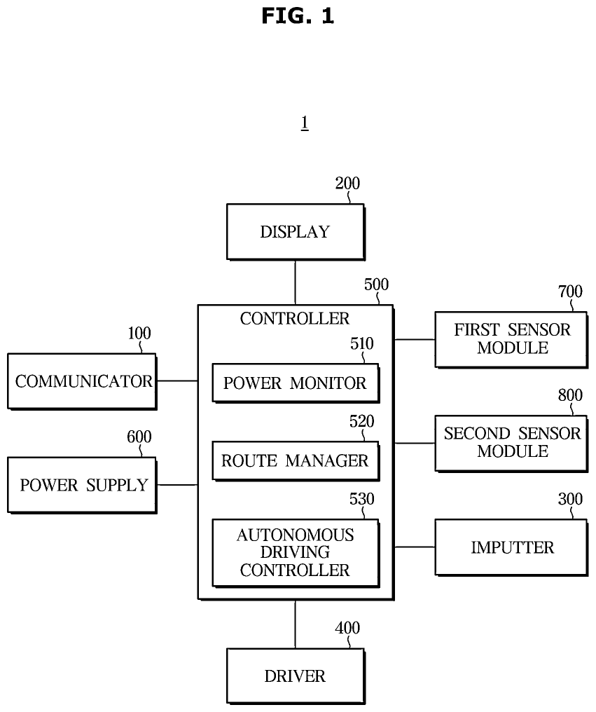

FIG. 1 is a view illustrating a control block diagram of a vehicle 1 according to an embodiment.

The vehicle 1 according to an embodiment may include a communicator 100, a display 200, a controller 500, a driver 400, a power supply 600, an inputter 300, a first sensor module 700, and a second sensor module 800.

The communicator 100 may receive a location signal. The location signal may include a global positioning system (GPS) signal capable of identifying a location of the vehicle.

Furthermore, the communicator 100 may receive road information. The road information may refer to information, such as road traffic conditions and road driving difficulty.

Furthermore, the communicator 100 may communicate with a server to receive location information of a charging station.

The communicator 100 may include one or more components that enable communication with an external device, and may include, for example, at least one of a short-range communication module, a wired communication module, and a wireless communication module.

The short-distance communication module may include various short-distance communication modules for transmitting and receiving signals via the wireless communication network in a short-distance, such as a Bluetooth module, an infrared communication module, a Radio Frequency Identification (RFID) communication module, a wireless local access network (WLAN) communication module, a near field communication (NFC) module, and a Zigbee communication module, and the like.

The wired communication module may include a variety of wired communication modules, such as a controller area network (CAN) communication module, a local area network (LAN) module, a wide area network (WAN) module, or a value added network (VAN) module and include various cable communication, such as universal serial bus (USB), a high definition multimedia interface (HDMI), a digital visual interface (HDMI), a recommended standard 232 (RS-232), a power line communication, or a plain old telephone service (POTS) as well.

The wireless communication module may include a wireless communication module supporting various wireless communication methods, such as a wireless fidelity (Wi-fi) module, a wireless broadband module, a global system for mobile (GSM) communication, a code division multiple access (CDMA), a wideband code division multiple access (WCDMA), a universal mobile telecommunications system (UMTS), a time division multiple access (TDMA), and a long term evolution (LTE), and the like. may include a wireless communication module supporting various wireless communication methods.

The wireless communication module may include a wireless communication interface including an antenna and a transmitter for transmitting a location signal. The wireless communication module may include a wireless communication interface including an antenna and a receiver for receiving the location signal.

The display 200 may output a manual driving switching guide message, a charging guide message, and the like, as is described below.

The manual driving switching guide message may refer to a message that the vehicle may switch to manual driving during autonomous driving, and types of the message is not limited thereto.

Furthermore, the charging guide message may refer to a message for guiding the vehicle to the charging station, and may output a driving suggestion to the charging station or a location of the charging station.

The display 200 may be provided such as a cathode ray tube (CRT), a digital light processing (DLP) panel, a plasma display panel (PDP), a liquid crystal display (LCD) panel, an electroluminescence (EL) panel, an electrophoretic display (EPD) panel, an electrochromic display (ECD) panel, a light emitting diode (LED) panel, or an organic light emitting diode (OLED) panel, and the like., but is not limited thereto.

The driver 400 may refer to an overall configuration for driving the vehicle.

The driver 400 may include components and modules related to driving of the vehicle, such as an engine, a brake, and a steering device.

The power supply 600 may be provided in a configuration capable of supplying power to the vehicle.

According to an embodiment, the power supply may be provided as a battery, but is not limited thereto.

The inputter 300 may be provided in a configuration capable of receiving a user input.

The inputter 300 may be provided to receive destination information including a destination location.

A user command may include a manual driving switching command and a charging command.

The manual driving switching command may refer to a command for turning off autonomous driving of the vehicle.

Moreover, the charging command may include a command for driving the vehicle to the charging station.

The inputter 300 may include a hardware device, such as various buttons or switches, a pedal, a keyboard, a mice, a track-ball, various levers, a handle, and a stick for user input.

Furthermore, the inputter 300 may include a graphical user interface (GUI), in other words, a software device such as a touch pad for user input. The touch pad may be implemented as a touch screen panel (TSP) to form a layer structure with the display 200.

The display 200 may also be used as the inputter 300 when configured as the TSP that forms the layer structure with the touch pad.

The first sensor module 700 may be provided as a current sensor or a voltage sensor to detect a capacity of the battery.

The second sensor module 800 may include a radar and a light detection and ranging (lidar) as a configuration for acquiring information for performing autonomous driving.

The controller 500 may determine an expected driving route of the vehicle based on the destination information.

The controller 500 may determine an expected power consumption of the vehicle corresponding to the expected driving route.

The controller 500 may control to change an autonomous driving state of the vehicle in the expected driving route based on the expected power consumption and the capacity of the battery.

The controller 500, when the capacity of the battery exceeds the expected power consumption, may control to reach the destination by performing autonomous driving optimized for the expected driving route.

In other words, when a power capacity of the power supply is sufficient, the controller 500 may use the optimized autonomous driving to the destination.

The controller 500 may receive road information in response to a driving area where the vehicle is expected to travel while driving along the expected driving route, and calculate an expected power consumption based on the road information of the driving area.

For example, when the road information includes information about heavy traffic on a road, the controller may determine that a lot of power will be consumed to perform autonomous driving on the road due to the heavy traffic.

The road information may include an amount of traffic according to the road, a driving difficulty, and the types of roads in the driving area.

The controller 500 may output a message guiding a switching from autonomous driving to manual driving in at least a part of the driving area on the display based on the power consumption.

The controller 500 may change a level of autonomous driving of the vehicle in at least a part of the driving route based on the power consumption of the vehicle and the capacity of the battery.

Specifically, when a capacity of the power supply is insufficient to perform autonomous driving during driving a driving route, the power consumption may be reduced by changing the level of autonomous driving in a part of the route.

The controller 500 may change the autonomous driving state of the vehicle by controlling power supplied to the second sensor module based on the power consumption of the vehicle and the capacity of the battery.

The controller 500, when the expected power consumption exceeds the capacity of the battery, may output a message guiding the vehicle to pass through the charging station on the display.

Furthermore, the controller 500 may include a power monitor 510, a route manager 520, and an autonomous driving controller 530.

The power monitor 510 determines whether driving is possible with an amount of power of the battery from a current location to the destination based on the destination transmitted from the destination information.

The controller 500 may receive information on whether or not autonomous driving is performed and the destination information from the power monitor, and determine whether driving to the destination is possible without charging.

When driving is impossible, the controller 500 may receive charging station information from the power monitor and determine whether to charge at a corresponding charging station.

In the case of manual driving, the controller 500 may transmit the destination to the power monitor and receive a list of charging stations in return so that the driver may identify whether to make a reservation when charging is desired.

The route manager 520 may generate a route desired for autonomous driving based on the destination and charging station request information transmitted from the power monitor.

The route manager, when driving is impossible due to insufficient output from the power supply, may select a charging station on the driving route and display for a driver through the display 200.

The controller 500 may include a memory (not shown) for storing data regarding an algorithm for controlling the operations of the components of the vehicle or a program that represents the algorithm, and a processor (not shown) that performs the above described operations using the data stored in the memory. In this case, the memory and the processor may be implemented as separate chips. Alternatively, the memory and the processor may be implemented as a single chip.

At least one component may be added or deleted corresponding to a performance of the components of the vehicle shown in FIGS. 1. Furthermore, it should be readily understood by those having ordinary skill in the art that mutual positions of the components may be changed corresponding to performance or structure of the system.

Meanwhile, each component shown in FIG. 1 may refer to software and/or hardware components, such as a field programmable gate array (FPGA) and an application specific integrated circuit (ASIC).

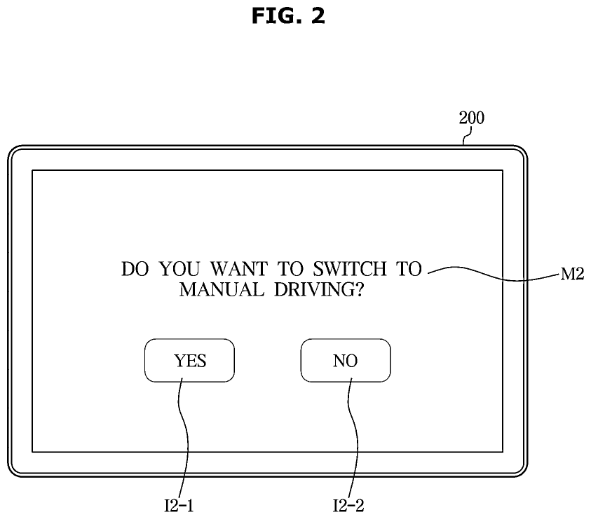

FIG. 2 is a view illustrating an operation of outputting a message guiding manual driving in autonomous driving according to an embodiment.

Referring to FIG. 2, the vehicle may receive destination information from a user through the inputter 300, and derive a driving route based on a location signal of the vehicle, the destination information, and an amount of power remaining in the power supply.

However, when the driving route is driven by autonomous driving, a situation in which power is insufficient may occur.

In other words, the controller 500 may determine whether the vehicle may drive to a location corresponding to the destination information by deriving the expected power consumption desired for driving along the driving route and comparing the expected power consumption with the capacity of the power supply.

When an amount of power demand exceeds the amount of power remaining, the controller 500 may output the manual driving switching guide message M2 on the display 200.

Meanwhile, when the message is output on the display 200, the user may input the manual driving switching command for terminating autonomous driving and switching to manual driving.

As shown in FIG. 2, the inputter 300 is provided as a touch pad on the display 200, and as the user selects “Yes (12-1)”, the vehicle may switch from autonomous driving to manual driving. Meanwhile, when the user selects “No (12-2)”, the vehicle may keep autonomous driving even though the power is insufficient.

On the other hand, the operation described in FIG. 2 is merely an embodiment of the present disclosure, and there is no limitation on the form of outputting a message or an operation of inputting a command by the user.

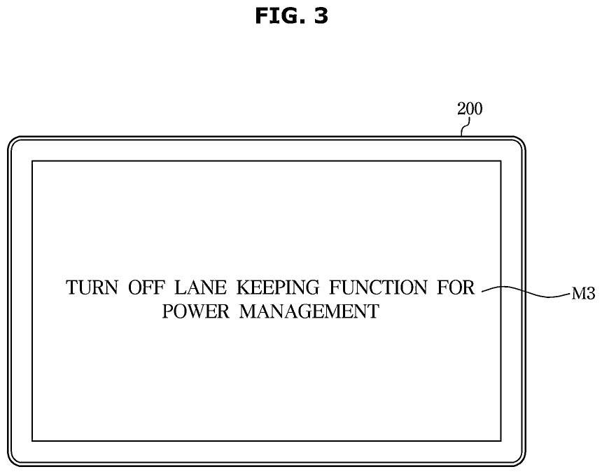

FIG. 3 is a view showing an operation of changing an autonomous driving state according to an embodiment.

Referring to FIG. 3, the controller outputs a message M3 for turning off a lane keeping function.

In other words, when the capacity of the power supply is insufficient to perform autonomous driving, the controller may change the autonomous driving state by turning off a part of an autonomous driving function.

Changing the autonomous driving state may include changing the level of autonomous driving and turning off a part of the second sensor module desired for autonomous driving.

Meanwhile, as described below, these operations may be changed in response to each driving route depending on an amount of traffic, a driving difficulty, and the like of the driving route.

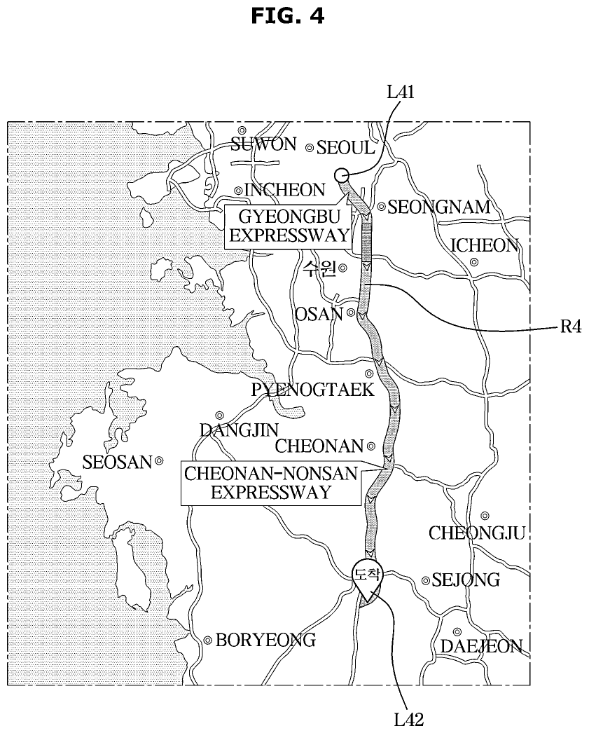

FIG. 4 is a view showing an operation in which a user sets a destination, and a vehicle determines an amount of power consumption corresponding to the destination, according to an exemplary embodiment.

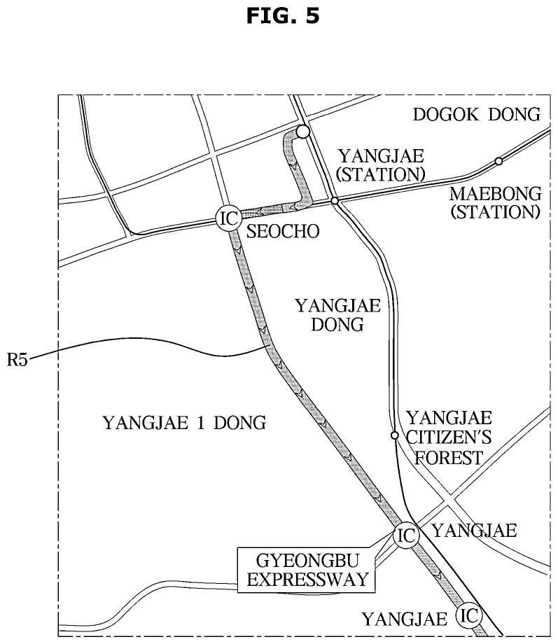

FIG. 5 is view showing an operation of controlling power according to an amount of traffic on a driving route according to an embodiment.

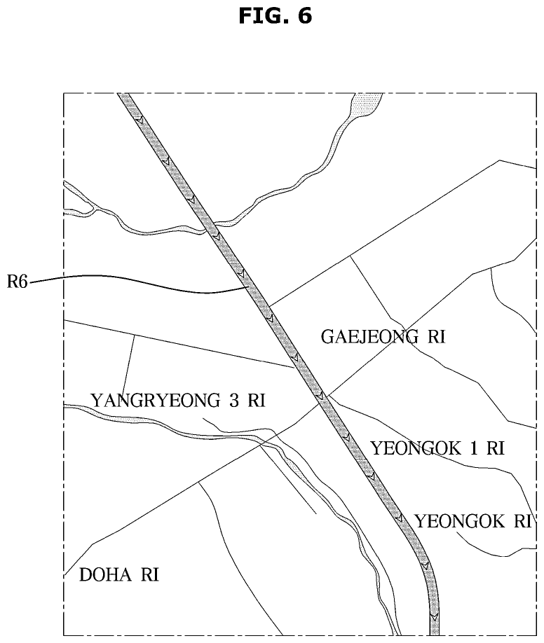

FIG. 6 is a view showing an operation of managing power when driving on a road having a low driving difficulty according to an embodiment.

Referring to FIGS. 4 to 6, according to the present disclosure, a destination L42 is input from a driver through the inputter.

FIG. 4 shows that Gongju (L42) is set as a destination starting from Seoul L41).

The controller may identify a route to the destination, and receive information about the amount of traffic and the driving difficulty of the road on a driving route R4 from the communicator.

For example, the controller may classify the driving route into expressways, highways, local roads, and downtown areas, and may assign weights to a junction (JC) and an inter change (IC).

Meanwhile, the controller may calculate power desired for driving along the driving route, and then calculate additional power consumed when autonomous driving is performed in this part and determine whether driving is possible.

Furthermore, the controller may configure an autonomous driving strategy to minimize a driver's driving load based on a power state of the power supply and the driving route.

FIG. 5 shows a driving route R5 with a large amount of traffic among the driving routes determined in FIG. 4. In addition, FIG. 6 shows a road having a small amount of traffic and a low driving difficulty among the driving routes determined in FIG. 4.

When power of the power supply is sufficient, the controller may derive an optimal route. When the amount of power in the power supply is sufficient, the optimal route may refer to the shortest time.

Furthermore, since the controller has sufficient power for autonomous driving, autonomous driving may be performed using all available sensors and control devices. In other words, when power of the power supply is sufficient, the controller may perform the optimized autonomous driving to the destination.

Meanwhile, when power is insufficient, the controller may derive the optimal route. In this case, an eco-driving assistant system (Eco-Das) based a map may be considered.

In other words, the controller may consider a time and a power consumption in a target to be minimized.

The controller compares the expected power consumption with power of the power supply, and since the amount of power is insufficient for autonomous driving, the level of autonomous driving may be differentially performed according to the driving situation.

In other words, during driving along the route of FIG. 4, in the area R5 with heavy traffic and high driving difficulty as shown in FIG. 5, the controller may efficiently manage power by switching autonomous driving to manual driving, or turning off a part of the second sensor module to perform autonomous driving, or lowering the level of autonomous driving itself.

Meanwhile, in FIG. 6, when the vehicle exits a downtown area and enters a highway R6 with a low driving load, autonomous driving may be performed because little power is consumed.

Meanwhile, such a situation, when a manual driving switching is desired, the controller may output a message guiding the switching from autonomous driving to manual driving as shown in FIG. 2.

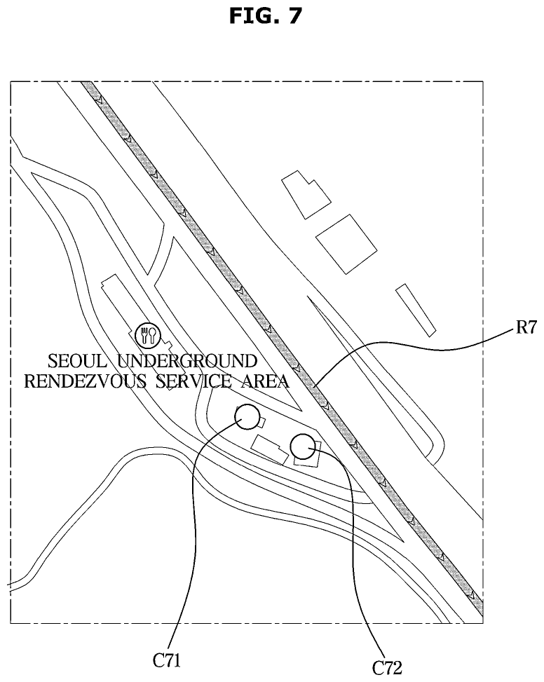

FIG. 7 is a view showing an operation of guiding a charging station according to an embodiment.

Referring to FIG. 7, when the controller calculates a route R7 to the destination where the driver wants to go, if power of the power supply is insufficient, the controller may further determine optimal charging stations C71 and C72.

In other words, when the expected power consumption exceeds the capacity of the battery, the controller may output a message guiding the vehicle to pass through the charging station on the display.

Since charging the battery before entering the downtown area on the route is more effective in reducing the driver's driving load, the controller may guide entrance of the charging station before entering the downtown area as shown in FIG. 7.

Meanwhile, the controller may set a function such as asking the driver whether to charge when the amount of power falls below a certain capacity in the vicinity of the arrival even when the capacity of the power supply is sufficient.

Furthermore, when the amount of power in the power supply is insufficient to perform autonomous driving, that is, when charging is desired while driving, charging may be induced before high-level of autonomous driving is desired.

Meanwhile, the operation described with reference to FIG. 7 is merely an exemplary embodiment of an operation in which the controller operates the vehicle to pass through the charging station, and there is no limitation on the operation as long as the controller causes the vehicle to pass through the charging station.

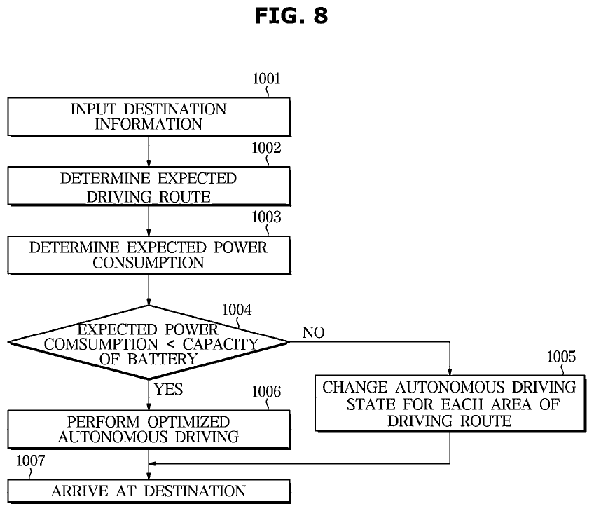

FIG. 8 is a flowchart according to an embodiment.

Referring to FIG. 8, the user may input destination information (in step 1001). In addition, the vehicle may determine an expected driving route based on the destination information (in step 1002).

The vehicle may then determine an expected power consumption to be consumed while the vehicle travels (in step 1003).

Meanwhile, the vehicle compares the expected power consumption with the capacity of the battery (in step 1004), and when the expected power consumption of the vehicle is less than the capacity of the battery, may perform optimized autonomous driving until the vehicle reaches the destination (in step 1006).

When the capacity of the battery is greater than the expected power consumption, the vehicle may arrive at the destination by performing optimized autonomous driving (in steps 1006 and 1007).

Meanwhile, when the expected power consumption is greater than the capacity of the battery, the controller may change the autonomous driving state for each area of the driving route of the vehicle (in step 1005). Specifically, in a place where there is a lot of traffic or driving difficulty is high, the level of autonomous driving may be lowered or autonomous driving may be switching to manual driving. The controller may control the vehicle to arrive at the destination based on these operations (in step 1007).

As is apparent from the above, the vehicle can provide optimized autonomous driving by distributing appropriate power based on the voltage of the battery and road information.

The computer-readable recording medium includes all kinds of recording media in which instructions which can be decoded by a computer are stored, for example, a read only memory (ROM), a random access memory (RAM), a magnetic tape, a magnetic disk, a flash memory, an optical data storage device, and the like.

Although exemplary embodiments of the present disclosure have been described for illustrative purposes, those having ordinary skill in the art would appreciate that various modifications, additions and substitutions are possible, without departing from the scope and spirit of the present disclosure. Therefore, exemplary embodiments of the present disclosure have not been described for limiting purposes.

What is claimed is:

1. A vehicle performing autonomous driving, comprising:
a display;
a driver configured to drive the vehicle;
an inputter configured to receive destination information related to a destination of the vehicle;
a power supply including a battery configured to supply electric power to the vehicle;
a first sensor module configured to detect a capacity of the battery; and
a controller configured to:
determine an expected driving route of the vehicle based on the destination information;
calculate an expected power consumption of the vehicle based on the expected driving route;
change an autonomous driving state of the vehicle in the expected driving route based on the expected power consumption and the capacity of the battery.

2. The vehicle of claim 1, wherein
the controller is configured to control the vehicle to reach the destination by performing an autonomous driving along the expected driving route when the detected capacity of the battery exceeds the expected power consumption.

3. The vehicle of claim 1, further comprising a communicator configured to receive road information,
wherein the controller is configured to receive the road information corresponding to a driving area where the vehicle is expected to travel while driving along the expected driving route, and calculate the expected power consumption based on the road information of the driving area.

4. The vehicle of claim 3, wherein
the road information includes an amount of traffic, a driving difficulty, and types of roads in the driving area.

5. The vehicle of claim 3, wherein
the controller is configured to output a message guiding a switching from an autonomous driving to a manual driving on the display in at least a part of the driving area based on the expected power consumption,

6. The vehicle of claim 3, wherein
the controller is configured to change a level of autonomous driving of the vehicle in at least part of the expected driving route based on the expected power consumption of the vehicle and the detected capacity of the battery.

7. The vehicle of claim 1, further comprising: a second sensor module including:
a radar, and a light detection and ranging sensor (lidar), wherein the controller is configured to change the autonomous driving state of the vehicle by controlling electric power supplied to the second sensor module based on the expected power consumption of the vehicle and the detected capacity of the battery.

8. The vehicle of claim 1, wherein
the controller is configured to output a message guiding the vehicle to pass through a charging station on the display when the expected power consumption exceeds the detected capacity of the battery.
